(19) United States
(12) Patent Application Publication
(10) Pub. No.: US 2015/0066682 A1
(43) Pub. Date: Mar. 5, 2015

(54) GIFT PACKAGE RECOMMENDATIONS

(71) Applicant: German Scipioni, San Jose, CA (US)

(72) Inventor: German Scipioni, San Jose, CA (US)

(21) Appl. No.: 14/018,367

(22) Filed: Sep. 4, 2013

(51) Int. Cl. G06Q 30/06

(52) U.S. Cl. CPC G06Q 30/0631
USPC 705/26.7

(57) ABSTRACT

Methods and systems can provide recommendations regarding gift packages. For example, a system can comprise a memory that stores information about a gift card recipient. A hardware processor can be in communication with the memory. The hardware processor can receive a communication that includes an indication of a desire of a user to purchase a gift card for the gift card recipient. The hardware processor can access the information. The hardware processor can determine, at least in part from the information, a recommendation for use of the gift card by the recipient. The hardware processor can facilitate sending of the recommendation to the user or the recipient, such as via text messaging or email.

### BACKGROUND

1. Technical Field

The present disclosure generally relates to electronic commerce and, more particularly, relates to methods and systems for providing recommendations related to gift packages, such as packages of products and/or activities associated with use of a gift card or the like.

2. Related Art

Gift cards are well known. Gift cards are similar to credit cards and debit cards. Typically, a gift card for a fixed amount of money is purchased by a gift giver and is subsequently given to a gift recipient. Some gift cards are only good for use with specific merchants. Examples of gift cards that are only good for use with specific merchants include gift cards for Best Buy, Old Navy, Kohl's, Sears, Lowes, Amazon, Barnes and Noble, Starbucks, and the Home Depot.

Other gift cards can be used with many different merchants. Examples of gift cards that can be used with many different merchants include gift cards from MasterCard, Visa, and American Express. Such gift cards can be used much like credit cards and can offer some of the advantages associated with the use of credit cards. For example, like a credit card user, a gift card user typically does not need to carry as much cash.

Gift cards provide gift givers with an easy way to purchase and give gifts. Gift cards provide gift recipients with a means for purchasing products and/or services that the gift recipient truly desires. Thus, gift cards are generally practical and desirable gifts for many occasions.

### BRIEF DESCRIPTION OF THE DRAWINGS

The included drawings are for illustrative purposes and serve only to provide examples of possible systems and methods for the disclosed gift package recommendations. These drawings in no way limit any changes in form and detail that may be made to that which is disclosed by one skilled in the art without departing from the spirit and scope of this disclosure.

FIG. 1 is a block diagram of a computing system that is adapted for implementing one or more examples of processes involving activities with respect to gift package recommendations, according to an embodiment.

FIG. 2 is a block diagram of an example of a computer system suitable for implementing on one or more devices of the computing system in FIG. 1, according to an embodiment.

FIG. 3 is a block diagram of a system for gift package recommendations, according to an embodiment.

FIG. 4 is a flow chart of a method for gift package recommendations, according to an embodiment.

### DETAILED DESCRIPTION

According to an embodiment, methods and systems provide recommendations related to gift packages. The gift packages can be packages of activities and/or product purchases associated with the use of a gift card or the like. The recommendations can include recommendations regarding what products to purchase, what activities to participate in, when to make purchases, where to make purchases, and the like. For example, when a user purchases a gift card to be given to the user's son for the son's birthday, the package can include products and activities suitable for the son's birthday. A schedule for making the purchases and attending the activities can be included. The products can be purchased automatically by the system. Reservations for the activities can be made automatically by the system.

The user can specify the gift recipient and/or occasion, such as at the time of purchase of the gift card. Alternatively, the system can infer the gift recipient and/or occasion from available information, as discussed herein. In either instance, the user can be provided with recommendations regarding products to purchase for the gift recipient and/or activities for the user and/or the gift recipient to participate in, such as by using the gift card for payment. Other forms of payment can be used. The cost of the recommendations can be less than, equal to, or more than the amount of the gift card.

Thus, products and activities can be recommended for the convenience of the user. For example, if the gift card is for a child's birthday, recommended places to eat, places to have fun, and products to purchase can be provided in the recommendation, which may be specific to the gift giver and/or the gift recipient, such as based on previous purchases, interests (from information obtained on social networks, calendars, etc.), and likes. The recommendations can be provided before the gift card is purchased, when the gift card is purchased, or after the gift card is purchased.

Exemplary applications of apparatuses and methods according to one or more embodiments are described in this section. These examples are being provided solely to add context and aid in the understanding of the embodiments. It will thus be apparent to one skilled in the art that the embodiments may be practiced without some or all of these specific details. In other instances, well known process steps have not been described in detail in order to avoid unnecessarily obscuring the disclosure. Other applications are possible, such that the following examples should not be taken as limiting.

The disclosure relates, in the various described embodiments, to devices, systems and methods involving activities with respect to gift package recommendations. In various particular embodiments, the systems or methods can involve one or more user devices in communication over a network. Such a network can facilitate a streamlined process involving gift package recommendations.

While the various examples disclosed herein focus on gift package recommendations, it will be understood that the various inventive principles and embodiments disclosed herein can be applied to other types of electronic commerce as well. For example, embodiments can be applied to online and brick and mortar purchasing generally.

According to an embodiment, a system can comprise one or more memories that store information about a gift card recipient. The information can include “likes” of a gift card recipient and/or calendar information of the gift card recipient. For example, the information can include “likes” of the gift card recipient that are obtained from a social networking website (such as Facebook or MySpace) of the recipient and can include calendar information of the gift recipient that was obtained from an electronic calendar (such as a Microsoft Outlook calendar) of the gift recipient.

The hardware processors can be in communication with the one or more memories. For example, the hardware processors can be in communication with the memories via a bus or a network. Thus, the hardware processors and the memories can be part of the same device or can be parts of different devices.

The hardware processors can receive or facilitate reception of a communication including an indication of a desire of a user to purchase a gift card or the like for the gift card recipient. The hardware processors can access or facilitate access to the information. The hardware processors can determine or facilitate determination, at least in part from the information, of one or more recommendations for use of the gift card by the recipient and/or one or more other people. The hardware processors can send or facilitate sending of the recommendations to the user or the recipient.

The recommendations can include a recommendation to purchase a product or a recommendation to participate in an activity. For example, the recommendations can include a recommendation to purchase a new BMX bicycle for the gift recipient and a recommendation of a BMX bicycle event to be attended by the gift recipient and friends of the gift recipient. The recommendations can be for any combination of gifts and/or products. The recommendations can be for any number of gift recipients and/or participants. The recommendations can be for related gifts and/or products. The recommendations can be for unrelated gifts and/or products.

According to an embodiment, the recommendations can include a package of products and activities. The package of products and activities can be related or coordinated with respect to one another. The products and activities can be coordinated to fit conveniently within the schedule of the gift recipient, the user, the attendees, and/or anyone else. For example, the products and activities can include breakfast on the way to a bicycle store, purchasing and assembly of a new bicycle, entry into a bicycle race with the new bicycle after leaving the bicycle store, a late lunch after the bicycle race, and a party with friends later in the evening. Attendance of the gift recipient's friends at the race and the party can be scheduled in advance to coordinate these activities among the attendees.

The products can be coordinated. The products can be coordinated to work together. For example, the gift recipient can be given a new BMX bicycle, as well as a helmet and pads to be used with the bicycle. Similarly, the activities can be coordinated.

Thus, the recommendations can be coordinated, so that they fit together (according to any criteria, such as location or time). For example, if going to a movie theater, then a recommendation can be to stop for yogurt along the way (especially if the gift recipient is known to enjoy yogurt or additional time with others after an event). Discounts or other incentives can be provided to encourage the use of coordinated activities or purchases.

According to an embodiment, the one or more hardware processors can infer an occasion and/or a gift recipient. For example, if the gift card is purchased just prior to a birthday of the user's son, then the system can infer that the occasion is a birthday and that the gift recipient is the user's son. Information for making such an inference can be obtained by the system from the user's calendar, calendars of others (such as the gift recipient), social networking websites, and any other useful source.

The recommendations can be appropriate for the occasion. For example, the occasion can be a bicycle race. The bicycle race can be inferred from the gift recipient's calendar or social networking website, which indicates participation in the race. The recommendation can relate to the race, as well as activities before and/or after the race.

The recommendations can be inferred from various different factors, such as geolocation, purchase history, demographics, sport's season, gift popularity, and/or the like. Geolocation can be obtained from the gift recipient's mobile device or social networking website. Geolocation can be provided by the user or the gift recipient (either manually or via GPS). Geolocation can be inferred, such as from airline ticket purchases or hotel reservations. For example, if the gift recipient's location is Hawaii, then a surfboard rental and boat tour can be recommended.

The gift recipient's purchase history can be obtained from an online seller or payment provider. The recommendations can be consistent with previous purchases made by the gift recipient. For example, if the gift recipient regularly purchases tickets to baseball games, then the recommendations can include tickets to an upcoming baseball game.

Information regarding the “likes” of the gift recipient can be obtained from the gift recipient's social networking website. For example, if the user likes the Red Sox, then tickets for the next Red Sox game in the gift recipient's home town can be recommended.

The gift recipient's demographics can be used to determine the recommendations. For example, if the user is a male between twenty-one and thirty years old, then sports related gifts can be recommended.

The sport's season (or any other season or time period) can be considered in making gift recommendations. For example, if it is baseball season, then tickets to a baseball game can be recommended.

The popularity of various gifts can be considered in making gift recommendations. For example, if water park tickets are presently a popular gift, then water park tickets can be recommended.

Any combination of such factors can be used to provide the recommendations. For example, if the gift recipient is in Aspen on the weekend of a major skiing contest, then the recommendations can include lift tickets and a dinner at a resort restaurant. As a further example, if the gift recipient is a man, baseball is in season, and the gift recipient will be in a city where his favorite team (per his social networking website) is playing on his birthday, then tickets to the baseball game can be recommended.

According to an embodiment, the hardware processors can coordinate the recommendations according to time or location. For example, the recommendations can be coordinated such that purchasing of products and/or participation in activities can tend to occur with a minimum of traveling and/or expense. Thus, for example, a route can be defined such that the user, the gift recipient, and/or activity attendees can travel along the route to purchase products and/or attend activities. The route can be a shortest route that facilitates the desired purchases and participation. Separate routes, e.g., different shortest routes, can be provided for the user, the gift recipient, and/or attendees of the activities.

According to an embodiment, the hardware processors can coordinate the recommendations to take advantage of one or more incentives, such as merchant incentives. For example, discounted sales of products and events can be included in the information used by the hardware processors to determine the recommendations. Thus, more cost efficient purchasing can be provided.

Such incentives can be coordinated with routing considerations. For example, a longer route can be selected if a substantially lower price is provided. As a further example, a higher price can be accepted if a substantially shorter route is provided. The user can prioritize criteria such as route length, and travel time, as well as product and activity pricing for use by the hardware processors in making recommendations. For example, the user can prioritize such criteria during a system set up process.

The user can override any such priorities, such as upon being presented with the recommendations. The system can provide notes along with the recommendations, wherein the notes can inform the user of priorities applied by the system to determine the recommendations. For example, if after reviewing the recommended package the user is willing to spend more money so as to reduce the travel time associated with the recommended package, then the user can modify the priorities accordingly.

According to an embodiment, the hardware processors can check a calendar for conflicts. The recommendations can be determined in a manner that avoids the conflicts. The calendar can be a calendar of the user, the gift recipient, and/or one or more of the attendees. Thus, if the user, the gift recipient, and/or one or more of the attendees cannot participate on one day, the activities can be schedule for another day.

The system can coordinate among all of the participants. Thus, the system can coordinate schedules, conflicts, travel times, and the like among the user, the gift recipient, and/or one or more of the attendees.

For example, if the user wants to take a child to a movie on Jul. 3, 2013, then that day can be checked for other conflicting obligations of the user, the child (if appropriate), and anyone else going with them. If one or more such conflicting obligations are identified, then another day can be scheduled or suggested.

Dates for activities can be optimized according to weather, how crowded a venue is, nearby activities, convenience to the user, convenience to the gift recipient, convenience to the attendees, or any other criteria. The user can provide a date or a range of potential dates for activities. The user can provide one or more excluded dates or ranges of excluded dates for activities.

According to an embodiment, the hardware processors can check a calendar for a best date to use the gift card. The calendar can be a calendar of the user, the gift recipient, and/or one or more of the attendees. The recommendations can be for using the gift card on the best date. For example, not all of the desired activities may be available on every potential date. However, if one date has the most desired activities, then that date can be considered the best date. As a further example, every potential date may have a conflict. However, if one date has fewer conflicts than other dates, then that date can be considered the best date.

According to an embodiment, the hardware processors can check any other information for a best date to use the gift card. For example, the hardware processors can check the weather, such as via an Internet weather forecasting website for a best date to use the gift card, such as when desired use of the gift card is dependent upon weather conditions. In this manner, scheduling the use of an out door batting cage or a golf game on a rainy day can be avoided, for example.

According to an embodiment, the one or more hardware processors can check for synergisms. The recommendations can be determined to facilitate the synergisms. Synergisms can include activities or products that enhance or better facilitate other activities or products. For example, if a desired activity for the gift recipient is to see a particular movie and the user needs to have new tires installed on the user's car, and there is also a tire shop near a theater where the movie is playing, then the recommendations can include watching the movie while the new tires are being installed.

According to an embodiment, the recommendations can include a package of products and activities that evolves over time. For example, the package can evolve over time such that new products and/or activities are added after the new products and/or activities become available or desirable. In this manner, the package can be automatically (with or without verification) modified to accommodate changing conditions. Similarly, the package can be automatically (with or without verification) modified to accommodate changes in attendees to the activities. Merchant's websites and the like can be monitored by the system for such changes in product offerings. Social networking website and the like can be monitored for such changes in product offerings and/or gift recipient likes.

As the group evolves, the package can evolve. For example, the dates, locations, and types of activities can change to accommodate the new characteristics of the changing group.

The package can be modified to accommodate changes in the number and/or demographics of attendees. For example, if girls are added to a boy's birthday party, then activities suitable for both boys and girls can be included. Thus, the package can vary dynamically, as conditions or information regarding the products and activities thereof changes.

According to an embodiment, the hardware processors can determine the recommendations based, at least in part, upon a size of a group attending an activity. Thus, smaller groups can engage in activities more suitable for smaller groups and larger groups can engage in activities more suitable of larger groups. Thus, activities can be tailored with respect to the size of the group.

According to an embodiment, the hardware processors can determine the recommendations based, at least in part, upon merchant incentives available for products and activities. Thus, products or activities that are discounted can be considered in determining the recommendations. For example, if two otherwise similar packages are candidates for a recommendation and one of packages is substantially less expensive than the other package, then the less expensive package can be recommended.

Options can be provided within a package recommendation. For example, a package recommendation including a trip to a movie theater to see a specific movie can have a plurality of options for dinner after the movie.

A plurality of different packages can be provided. The user can choose one or more of the different packages. Packages can be combined, subtracted, and/or modified by the user or someone authorized by the user.

The hardware processors can determine a recommendation for an activity based, at least in part, upon merchant incentives available for the activity, taking into account a size of a group attending the activity. Thus, merchant incentives that depend upon the number of participants taking advantage of the merchant incentives can be more appropriately considered. As the size of the group changes, discounts that depend upon group size can be considered in modifying the package.

The package can be enhanced based upon date, location, attendees, weather, other activities, size of group, venue, size of venue, or any other criteria or combination of criteria. For example, a larger group may be eligible for a venue or discount for which a smaller group is ineligible. Any desired criteria can be used by the system to provide an enhanced package. The user can define criteria, such as during a setup process for the system.

Information used to define and/or modify the package can be obtained from an account (such as a merchant account or a payment account of the user and/or of the gift recipient), from a social networking website, from the Internet, from others who know the user and/or form the gift recipient, and/or any other source.

According to an embodiment, sharing of payments, such as for the package, can be facilitated. For example, a total money amount for the package can be shared among the user and others who are specified by the user. According to an embodiment, such sharing can be defined on a case-by-case basis. According to an embodiment, such sharing can be defined during a setup process, such as by designating with whom payment is to be shared for particular occasions and/or for particular gift recipients.

According to an embodiment, the system can make arrangements regarding the package. For example, the system can make reservations for activities requiring reservations. The system can provide prepayment for activities requiring prepayment. The system can pay for products that are purchased as part of the package.

According to an embodiment, gifts among members of the group can be coordinated to prevent duplication and thus reduce the likelihood of unwanted gifts. Members of the group who purchase gifts can enter the gifts, such as via a website. Purchasing of members of the group can be automatically monitored by the system and the members can be notified of suspected gift duplications.

Thus, various aspects of the gift package recommendation can be coordinated. Such coordination can reduce expenses of members of the group while enhancing convenience for the members of the group.

The system can facilitate feedback regarding the package. Previously provided feedback within the system (and/or any other feedback, such as that provided by Yelp, online merchants, and payment providers) can be considered when defining a package. Thus, a product or activity that has excessive negative feedback can be given low or no priority in determining the package. Similarly, a product or activity that has positive feedback can be given high priority in determining the package.

According to an embodiment, a method can comprise storing, in one or more memories, information about a gift card recipient. A communication can be received, such as electronically via one or more hardware processors. The communication can include an indication of a desire of the user to purchase a gift card for the gift card recipient. Information can be accessed, such as via the one or more hardware processors. One or more recommendations can be determined, such as via the one or more hardware processors and at least in part from the information, for use of the gift card by the recipient. The recommendations can be sent, such as electronically by one or more hardware processors, to the user and/or the recipient.

According to an embodiment, a computer program product can comprise a non-transitory computer readable medium. The non-transitory computer readable medium can have computer readable and executable code for instructing one or more processors to perform any of the methods disclosed herein.

The one or more memories and one or more hardware processors can be part of the same device, e.g., server. The one or more memories and one or more hardware processors can be part of the different devices, e.g., servers. The one or more memories and one or more hardware processors can be co-located. The one or more memories and one or more hardware processors can be located in different places, e.g., different rooms, different buildings, different cities, or different states.

### Systems and Devices

In the following detailed description, references are made to the accompanying drawings, which form a part of the description and in which are shown, by way of illustration, various specific embodiments. Although these embodiments are described in sufficient detail to enable one skilled in the art to practice the embodiments, it is understood that these examples are not limiting, such that other embodiments may be used, and changes may be made without departing from the spirit and scope of the disclosure.

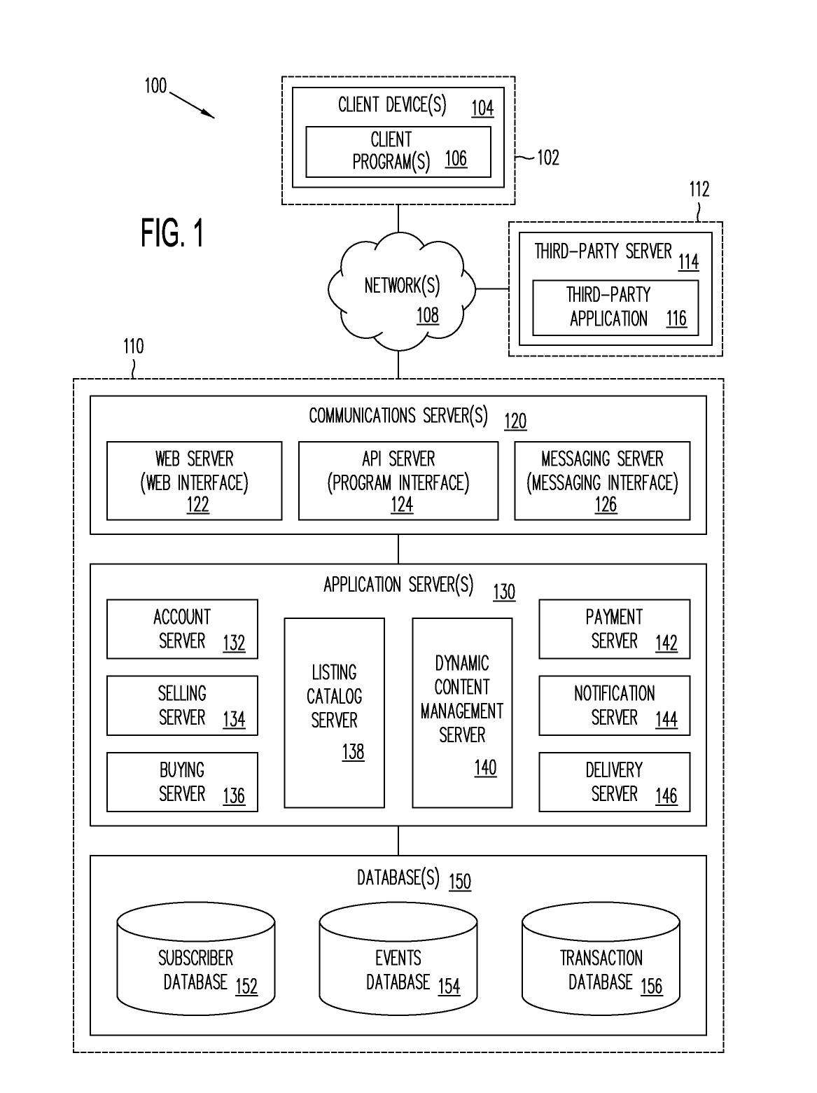

Referring now to FIG. 1, an exemplary embodiment of a computing system adapted for implementing one or more processes involving gift package recommendations is illustrated in block diagram format. As shown, computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a mobile computing device, a PC, and/or any other computing device having computing and/or communications capabilities in accordance with the described embodiments. Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated.

In various embodiments, computing system 100 can include, among other elements, a third party 112, which may comprise or employ a third-party server 114 hosting a third-party application 116. In various implementations, third-party server 314 and/or third-party application 116 may host a web site associated with or employed by a third party 112. For example, third-party server 114 and/or third-party application 116 may enable network-based system 110 to provide client 102 with additional services and/or information, such as online sales and/or payment facilitation. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various gift package recommendation services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an gift package recommendation system, application servers 130 of network-based system 110 may provide various online marketplace and payment providing services including, for example, account services, buying services, selling services, listing catalog services, dynamic content management services, delivery services, payment services, and notification services. Application servers 130 may include an account server 132, a buying server 134, a selling server 136, a listing catalog server 138, a dynamic content management server 140, a payment server 142, a notification server 144, and/or a delivery server 146 structured and arranged to provide such gift package recommendation and/or other services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

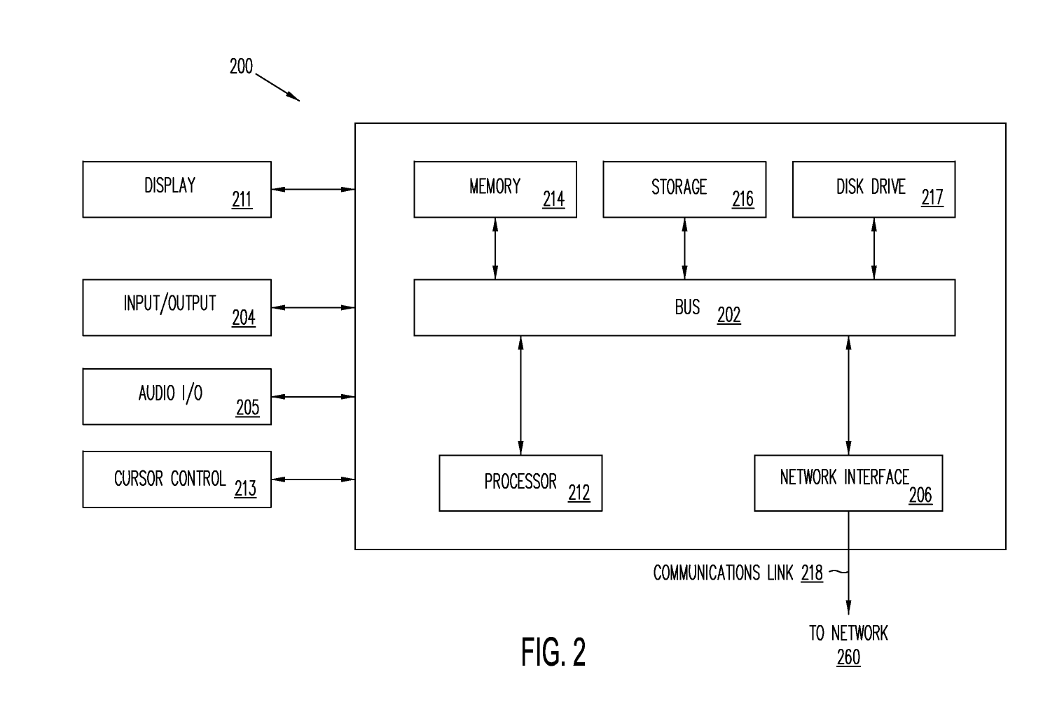

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart phone, a computing tablet, a personal computer, laptop, PDA, Bluetooth device, key FOB, badge, etc.) that is capable of communicating with a network. The gift package recommendations system, merchants, and/or a payment provider may utilize a network computing device (e.g., a network server) capable of communicating with the network. It should be appreciated that each of the devices utilized by users, the gift package recommendations system, merchants, and/or payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, or a payment provider server via a network. In an embodiment, the transmission is wireless, although other transmission mediums and methods may also be suitable. A processor 212, which can be a micro-controller, digital signal processor (DSP), or other hardware processing component, processes these various signals, such as for display on computer system 200 or transmission to other devices over a network 260 via a communication link 218. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In an embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments, execution of instruction sequences for practicing the embodiments may be performed by a computer system. In various other embodiments, a plurality of computer systems coupled by a communication link (e.g., LAN, WLAN, PTSN, or various other wired or wireless networks) may perform instruction sequences to practice the embodiments in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Social networking information can include “likes”, interests, past events, wants, owns and so forth, such as may be found on social networking websites such as Facebook, YouTube, Twitter, LinkedIn, Yelp, MeetMe, MyYearbook, Google+, MySpace, Pinterest, and the like, among other possible websites. External information can include song or artist lists on a separate user device or profile, as well as data from media websites or applications, such as Pandora, Spotify, iTunes, and the like.

### Gift Package Recommendations

As will be readily appreciated, the foregoing networks, systems, devices, and numerous variations thereof can be used to implement gift package recommendations. As noted with respect to FIG. 2 above, a computer system 200 can include one or more processors 212 and one or more memories or storage devices 214, 216. Such a computer system 200 can be part of a user device, part of one or more servers on a network-based system, or some combination thereof. In particular, a given computing system can include a first memory device or storage component adapted to store information regarding one or more users of the system, as well as a second memory device or storage component adapted to store information regarding gift package recommendations.

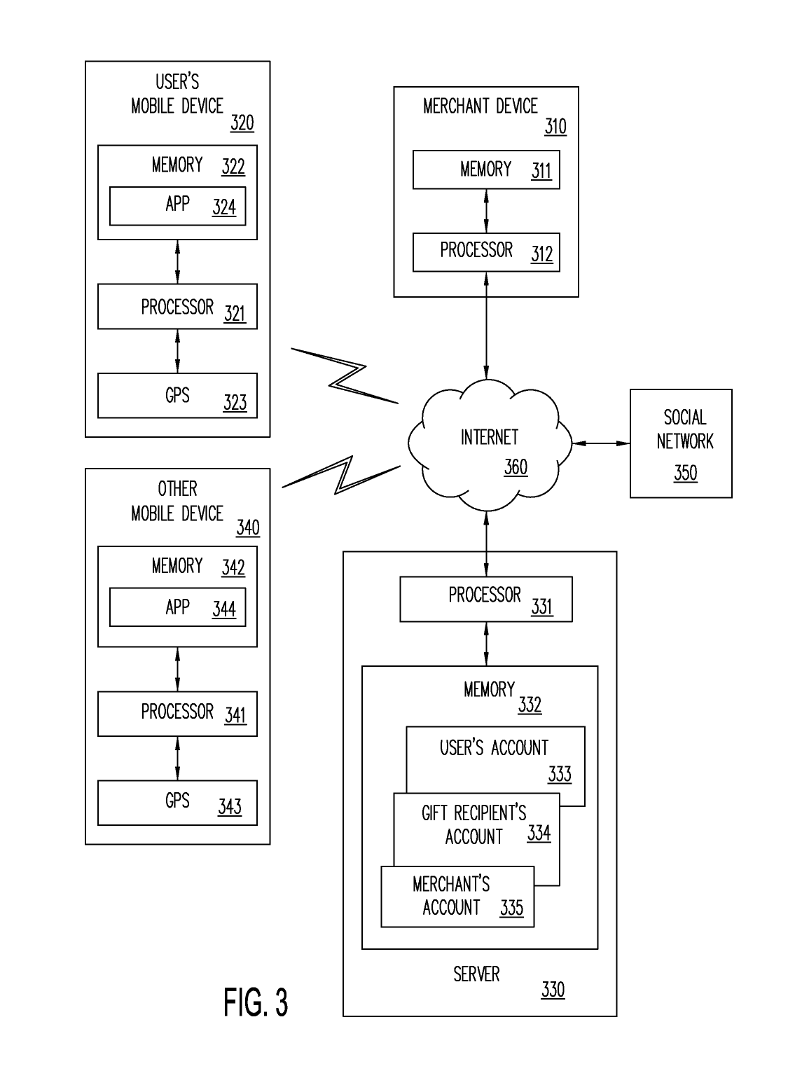

FIG. 3 is a block diagram of a system for providing gift package recommendations, according to an embodiment. The system can include a merchant device 310, a mobile device 320, one or more other mobile devices 340, a server 330, and/or a social network 350. The functions and components discussed herein can be split and/or shared among the merchant device 310, the mobile device 320, the one or more other mobile devices 340, the server 330, and/or any other devices or systems, as desired.

The merchant device 310 can comprise a merchant checkout terminal, a computer, and/or a server, for example. The merchant device 310 can include a memory 311 and a processor 312. The merchant device 310 can be used for processing purchases from the merchant. The merchant device 310 can be used for making sales and/or providing gift package recommendations.

The mobile device 320 can be carried by the user. The mobile device 320 can comprise a cellular telephone, a smart telephone, a hand held computer, a laptop computer, a notebook computer, or a tablet computer, for example. The mobile device 320 can include a processor 321, a memory 322, and a global positioning system (GPS) 323.

The mobile device 320 can be used for routine telephone calls, text messaging, web browsing, and the like. The mobile device 320 can be used for providing gift package recommendations.

An app 324 can be stored in the memory 322 and executed by the processor 321. The app 324 can be used for making purchases, providing payments, and/or facilitating gift package recommendations. The app 324 can be a payment provider app that facilitates use of the mobile device with a payment provider, such as PayPal and that also facilitates gift package recommendations.

The GPS 323 can be used by the system for facilitating the gift package recommendations. For example, the activities of the package and places to purchase products of the package can be dependent upon the user's location, as provided by the GPS 323.

The one or more other mobile devices 340 can be similar to the mobile device 310. The one or more other mobile devices 340 can be carried by the gift recipient and/or other attendees to the events. Each other mobile device 340 can comprise a cellular telephone, a smart telephone, a hand held computer, a laptop computer, a notebook computer, or a tablet computer, for example. Each of one or more other mobile devices 340 can include a processor 341, a memory 342, and a global positioning system (GPS) 343.

The other mobile devices 340 can be used for routine telephone calls, text messaging, web browsing, and the like. The other mobile devices 340 can be used for receiving gift package recommendations.

An app 344 can be stored in the memory 342 and executed by the processor 341. The app 344 can be used for making purchases, providing payments, and/or facilitating gift package recommendations.

The GPS 343 can be used by the system for facilitating the gift package recommendations. For example, the activities of the package and places to purchase products of the package can be dependent upon the gift recipient and attendees locations, as provided by GPS 343.

The server 330 can comprise a server of a payment provider, such as Paypal, Inc. The server 330 can be a single server or can be a plurality of servers. The server 330 can include one or more processors 331 and a memory 332. The memory 332 can be a memory of the server 330 or a memory that is associated with the server 330. The memory 332 can be a distributed memory. The memory 332 can store a user account 333 and a merchant account 334. The server 330 can be a payment server, a merchant server, a dedicated gift package recommendation server, or any other type of server.

Generally, the merchant device 310, the mobile device 320, the other mobile devices 340 and the server 330 can perform functions discussed herein. That is, at least to some extent, a function that is discussed herein as being performed via a particular one of these devices can be performed by a different one of these devices, by a combination of these devices, and/or by other devices.

The merchant device 310, the mobile device 320, the other mobile devices 340, the server 330, and the social network 350 can communicate with one another via a network, such as the Internet 360. The merchant device 310, the mobile device 320, the other mobile devices 330, and the server 330 can communicate with one another via one or more networks, such as local area networks (LANs), wide area networks (WANs), cellular telephone networks, and the like. The merchant device 310, the mobile device 320, the other mobile devices 340, the server 330, and the social network 350 can communicate with one another via a network, such as the Internet 360 can communicate with one another, at least partially, via one or more near field communications (NFC) methods or other short range communications methods, such as infrared (IR), Bluetooth, WiFi, and WiMax.

### Methods

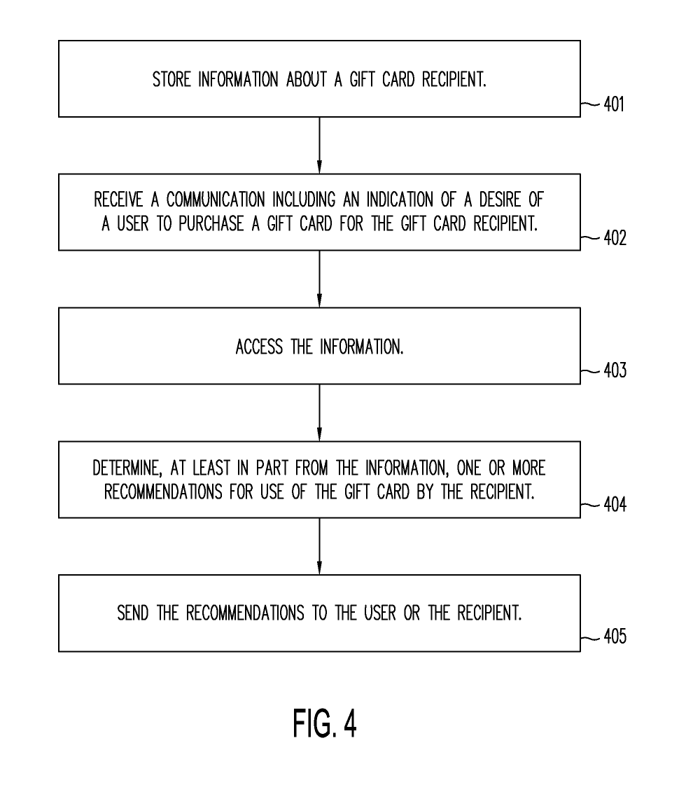

FIG. 4 is a flow chart that describes an example of operation of the gift package recommendation system, according to embodiments thereof. Note that one or more of the steps described herein may be combined, omitted, or performed in a different order, as desired or appropriate.

One or more hardware processors, such as processor 331 of server 330, can store information about a gift card recipient, as shown in step 401. The information can be stored in one or more memories, such as memory 332 of server 330. The information can be stored by various other processors in various other memories. The information can be stored in an account, such as user or gift recipient account 334 of memory 332.

The processor 331 can be in communication with the memory 332 and can be operable to receive a communication including an indication of a desire of a user to purchase a gift card for the gift card recipient, as shown in step 402. The communication can be initiated by the user when the user begins the process of purchasing a gift card. The communication can be initiated manually, such as by the user selecting a “Gift Package Recommendation” button or icon via the app 324 on the user's mobile device 320. The communication can be initiated automatically, such as by the app 324 being used to purchase the gift card.

The processor 331 can be operable to access the information, as shown in step 403. For example, the processor 331 can access the gift recipient's account 334 to obtain the information.

The processor 331 can be operable to determine, at least in part from the information, one or more recommendations for use of the gift card by the recipient, as shown in step 404. The information can include “likes” of the gift recipient, a purchase history of the gift recipient, contacts of the gift recipient, and/or any other information that can be used to determine or infer the recommendations.

The processor 331 can be operable to send the recommendations to the user or the recipient, as shown in step 405. The processor 331 can be operable to send the recommendations to the user or the recipient via text messaging or email, such as via the user's mobile device 320 or the other mobile device 340.

After receiving the recommendations, the user can ignore the recommendations, modify the recommendations, or act upon the recommendations. For example, the user can merely give the gift card to the gift recipient without regard to the recommendations. The user can act upon some of the recommendations and modify other recommendations. Modifications to the recommendations can be communicated from the user to the system so that the system can manage the gift package, such as by making purchases and/or reservations on behalf of the user and/or gift recipient.

The one or more memories and/or the one or more processors can be one or more memories and/or the one or more processors of the merchant device, 310, the user device 320, the other mobile devices 340, the server 330, the social network 350, and/or any other device or system. Memories and/or processors from any number of devices, systems, and entities can cooperate to perform the gift package recommendation method disclosed herein.

In implementation, at least some of the various embodiments may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In an embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the embodiments.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user.

As used herein, the term “store” can include any business or place of business. The store can be a brick and mortar store or an online store. Examples of stores can include supermarkets, discount stores, book stores, convenience stores, restaurants, gas stations, auto repair shops, and movie theaters. The store can be any person or entity that sells a product and/or provides a service.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, meals, hotel rooms, automotive repair, haircuts, digital music, and books. The product can be a single item or a plurality of items. For example, the product can be a tube of toothpaste, a box of laundry detergent, three shirts, and a donut.

As used herein, the term “activity” can refer to any event, program, game, party, meal, or other occurrence in which a person may participate. For example, an activity can be an occurrence for which a gift card can be used to pay for participating.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

As used herein, the term “card” can refer to any card or other device that can be used to make a purchase in place of cash. For example, the card can be a bank card, credit card, debit card, gift card, or other device. The card can be a token, such as a hardware token or a software token. The card can be stored in and/or displayed upon a user device, such as a cellular telephone.

As used herein, the term “gift card” can refer to any card or other device that can be given as a gift. Examples of gift cards include those from Best Buy, Old Navy, Kohl's, Sears, Lowes, Amazon, Barnes and Noble, Starbucks, the Home Depot, MasterCard, Visa, and American Express.

The foregoing disclosure is not intended to limit the disclosure to the precise forms or particular fields of use disclosed. It is contemplated that various alternate embodiments and/or modifications, whether explicitly described or implied herein, are possible in light of the disclosure. Having thus described various example embodiments of the disclosure, persons of ordinary skill in the art will recognize that changes may be made in form and detail without departing from the scope of the disclosure. Thus, the disclosure is limited only by the claims.

What is claimed is:

1. A system comprising:
one or more memories storing information about a gift card recipient;
one or more hardware processors in communication with the one or more memories and operable to:
receive a communication including an indication of a desire of a user to purchase a gift card for the gift card recipient;
access the information;
determine, at least in part from the information, one or more recommendations for use of the gift card by the gift card recipient and at least one other person; and
send the recommendations to the user or the gift card recipient.

2. The system of claim 1, wherein the recommendations include a recommendation to purchase a product or a recommendation to participate in an activity.

3. The system of claim 1, wherein the recommendations include a package of products and activities.

4. The system of claim 1, wherein:
the one or more hardware processors are operable to infer an occasion; and
the recommendation is appropriate for the occasion.

5. The system of claim 1, wherein:
the one or more hardware processors are operable to infer an occasion;
the recommendation is appropriate for the occasion; and
the occasion is inferred from a calendar of the user.

6. The system of claim 1, wherein:
the one or more hardware processors are operable to infer an occasion;
the recommendation is appropriate for the occasion; and
the occasion is inferred from a social network.

7. The system of claim 1, wherein the one or more hardware processors are operable to coordinate the recommendations according to time or location.

8. The system of claim 1, wherein the one or more hardware processors are operable to coordinate the recommendations to take advantage of one or more merchant incentives.

9. The system of claim 1, wherein:
the one or more hardware processors are operable to check a calendar for conflicts; and
the recommendations are determined to avoid the conflicts.

10. The system of claim 1, wherein:
the one or more hardware processors are operable to check a calendar for a best date to use the gift card; and
the recommendations are for using the gift card on the best date.

11. The system of claim 1, wherein:
the one or more hardware processors are operable to check for synergisms; and
the recommendations are determined to facilitate the synergisms.

12. The system of claim 1, wherein:
the recommendations include a package of products and activities; and
the one or more hardware processors are operable to evolve the package over time.

13. The system of claim 1, wherein:
the recommendations include a package of products and activities; and
the one or more hardware processors are operable to evolve the package over time such that new products and/or activities are added after the new products and/or activities become available.

14. The system of claim 1, wherein:
the recommendations include a package of activities; and
the one or more hardware processors are operable to evolve the package over time to accommodate changes in attendees to the activities.

15. The system of claim 1, wherein:
the recommendations include a package of activities; and
the one or more hardware processors are operable to evolve the package over time to accommodate changes in demographics of attendees to the activities.

16. The system of claim 1, wherein the one or more hardware processors are operable to determine the recommendations based, at least in part, upon a size of a group attending an activity.

17. The system of claim 1, wherein the one or more hardware processors are operable to determine the recommendations based, at least in part, upon merchant incentives available for products and activities.

18. The system of claim 1, wherein the one or more hardware processors are operable to determine a recommendation for an activity based, at least in part, upon merchant incentives available for the activity, taking into account a size of a group attending the activity.

19. A method comprising:
receiving, electronically via one or more hardware processors, a communication including an indication of a desire of a user to purchase a gift card for a gift card recipient;
accessing, via the one or more hardware processors, the information;
determining, via the one or more hardware processors and at least in part from the information, one or more recommendations for use of the gift card by the gift card recipient and at least one other person; and
sending, electronically by one or more hardware processors, the recommendations to the user or the gift card recipient.

20. A computer program product comprising a non-transitory computer readable medium having computer readable and executable code for instructing one or more processors to perform a method, the method comprising:
receiving a communication including an indication of a desire of a user to purchase a gift card for a gift card recipient;
accessing the information;
determining, at least in part from the information, one or more recommendations for use of the gift card by the gift card recipient and at least one other person; and
sending the recommendations to the user or the gift card recipient.
